(19) United States
(12) Patent Application Publication
(10) Pub. No.: US 2024/0246355 A1
(43) Pub. Date: Jul. 25, 2024

(54) CANVAS CORNER FIXING DEVICE FOR ALUMINUM CANVAS FRAME

(71) Applicant: Ki Bum KIM, Gyeongsangbuk-do (KR)

(72) Inventor: Ki Bum KIM, Gyeongsangbuk-do (KR)

(21) Appl. No.: 18/386,633

(22) Filed: Nov. 3, 2023

(30) Foreign Application Priority Data
Jan. 20, 2023 (KR) 10-2023-0008611

(51) Int. Cl. B44D 3/18

(52) U.S. Cl. CPC B44D 3/18

(57) ABSTRACT

A canvas corner fixing device for an aluminum canvas frame includes: canvas frame bodies each made by means of extrusion molding and having a hollow portion formed therein and a fixing groove and a coupling groove formed on the rear surface thereof; a corner coupling member having a body, a support located at the inside of the body, and frame body insertion holes formed on one side in a vertical direction thereof and on one side in a horizontal side thereof; and a fixing member made of a soft synthetic resin and having coupling protrusions protruding from one side in a vertical direction thereof and from one side in a horizontal side thereof.

### BACKGROUND

The present invention relates to a canvas corner fixing device for an aluminum canvas frame, more particularly, to a canvas corner fixing device for an aluminum canvas frame that is capable of fixing canvas to each corner of the aluminum canvas frame for fixing the canvas thereto by means of elastic pins, without any use of wood.

Generally, painting such as western painting or oil painting is made on oil painting canvas as a kind of fabric that is fixed to a canvas frame.

That is, the outer edges of the canvas stretch out and are thus fixed to the canvas frame to a state where the canvas is kept tightly pulled, and in this case, nails, staples, thumbtacks, etc. are used as means for fixing the canvas to the square canvas frame.

To allow the nails, staples, and thumbtacks to easily hit into the canvas frame, generally, the conventional canvas frame is made of wood, but the wood canvas frame may be varied in moisture content according to the humidity in the air and thus easily distorted in shape. Further, the moisture contained in the wood is discharged according to external environments, and in this case, wood resin is discharged together with the moisture and soaks into the canvas, thereby causing the painting to be damaged.

That is, the canvas frame and the canvas stick together on a portion where they are brought into close contact with each other by means of the moisture discharged from the wood, so that molds are created from the portion, thereby seriously degrading the value of the painting.

To solve such problems the wood canvas frame has had, accordingly, various canvas frames made of aluminum as a lightweight metal have been recently proposed, which are suggested in Korean Patent No. 1226698 and Korean Patent No. 2319322. Referring to the conventional technologies, a canvas frame includes a square frame body made by connecting horizontal and vertical bars each having a pipe structure made of a lightweight metal and having a hollow portion formed therein and wood fixed to the edges of the rear surface of the square frame body.

Accordingly, canvas on which painting is made comes into close contact with the front surface of the canvas frame made of the metal, and the outer edges of the canvas are fixed to the wood located on the rear surface of the canvas frame, so that since the canvas on which the painting is made is brought into contact with the front surface of the canvas frame made of the metal, it is safely spaced from the molds created due to the moisture discharged from the wood and the resin discharged from the wood, thereby lowering a degree of contamination thereof.

However, the wood for fixing the canvas frame or the canvas still exists in the conventional technologies, and accordingly, the conventional technologies just have a difference in the degree of contamination and contamination time from the existing wood canvas frame. As time passes, therefore, moisture, resin, and molds may come from the wood located on the rear surface of the canvas frame, and they gradually spread to the front surface of the canvas so that the painting becomes contaminated.
Patent literatures: Korean Patent No. 1226698 and Korean Patent No. 2319322

### SUMMARY OF THE INVENTION

A canvas fixing device for an aluminum canvas frame, which is configured to directly fix the canvas to canvas frame bodies by means of fixing pins, without any use of the wood for fixing the canvas to the aluminum canvas frame, to allow the canvas to be spaced from the molds created by the moisture discharged from the wood and the resin discharged from the wood, so that the canvas is prevented from being contaminated, has been filed (with Korean Patent Application Laid-open No. 10-2023-0007045) in the same applicant as the present invention. Accordingly, the present invention has been made in view of the above-mentioned problems occurring in the related art, and it is an object of the present invention to provide a canvas corner fixing device for an aluminum canvas frame that is capable of fixing canvas to canvas frame corners to which the canvas is not fixed by fixing pins.

### Technical Solution

To accomplish the above objects, according to the present invention, there is provided a canvas corner fixing device for an aluminum canvas frame, including: canvas frame bodies each made by means of extrusion molding and having a hollow portion formed therein and a fixing groove and a coupling groove formed on the rear surface thereof; a corner coupling member having a body, a support located at the inside of the body, and frame body insertion holes formed on one side in a vertical direction thereof and on one side in a horizontal side thereof; and a fixing member made of a soft synthetic resin and having coupling protrusions protruding from one side in a vertical direction thereof and from one side in a horizontal side thereof, wherein the fixing member is inserted into the body of the corner coupling member, and the frame body insertion holes of the corner coupling member and the coupling protrusions of the fixing member are inserted into the hollow portions of the canvas frame bodies, so that the corner coupling member, the fixing member, and the canvas frame bodies are coupled to one another.

According to the present invention, the canvas corner fixing device for the aluminum canvas frame is configured to allow the corner coupling member and the fixing member to be coupled to the hollow portions of the frame bodies, thereby simply making the canvas frame to the form of square, and configured to allow the fixing member to be located at each corner of the canvas frame so that upon the installation of the canvas, the canvas overlayed on top of the corner of the canvas frame is easily fixed to the fixing member by means of the fixing staple.

### BRIEF DESCRIPTION OF DRAWINGS

FIG. 1 is a perspective view showing a state where a canvas corner fixing device for an aluminum canvas frame according to the present invention is fixed to the aluminum canvas frame.

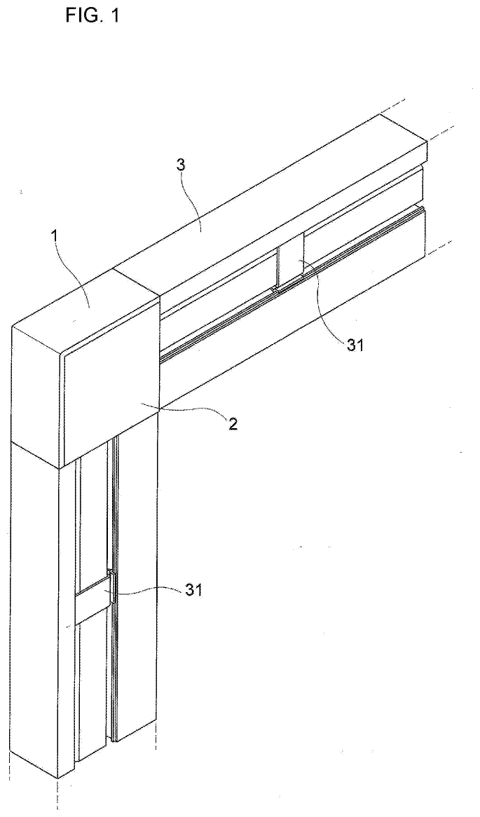

FIG. 2 is an exploded perspective view showing components of the canvas corner fixing device according to the present invention.

FIG. 3 is a sectional view showing a coupled relation among a corner coupling member, a fixing member, and a frame body of the canvas corner fixing device according to the present invention.

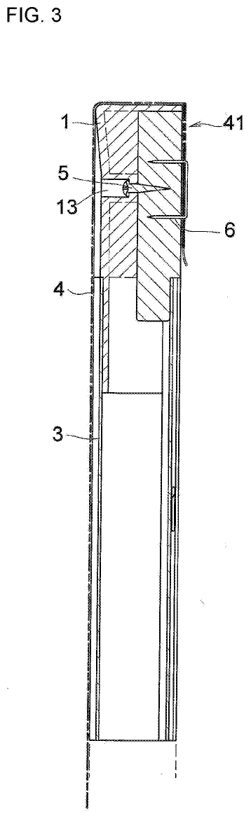

FIG. 4 is a perspective view showing a state where a through hole is formed on the fixing member of the canvas corner fixing device according to the present invention.

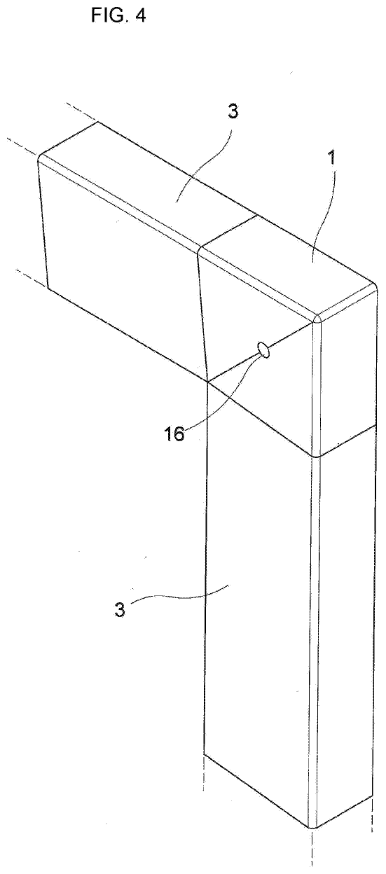

FIG. 5 is an exemplary view showing the canvas frame made with the canvas corner fixing device according to the present invention.

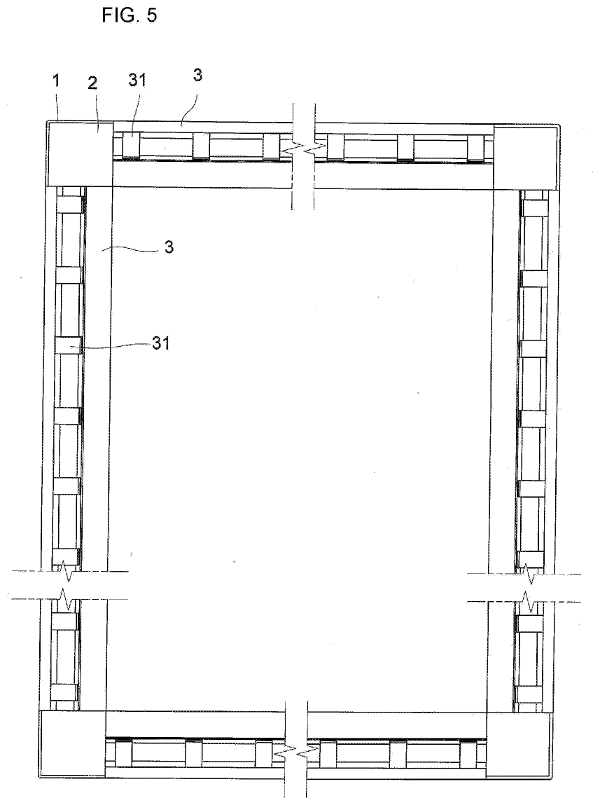

### DETAILED DESCRIPTION OF THE INVENTION

Hereinafter, the present invention will be explained in detail with reference to the attached drawings.

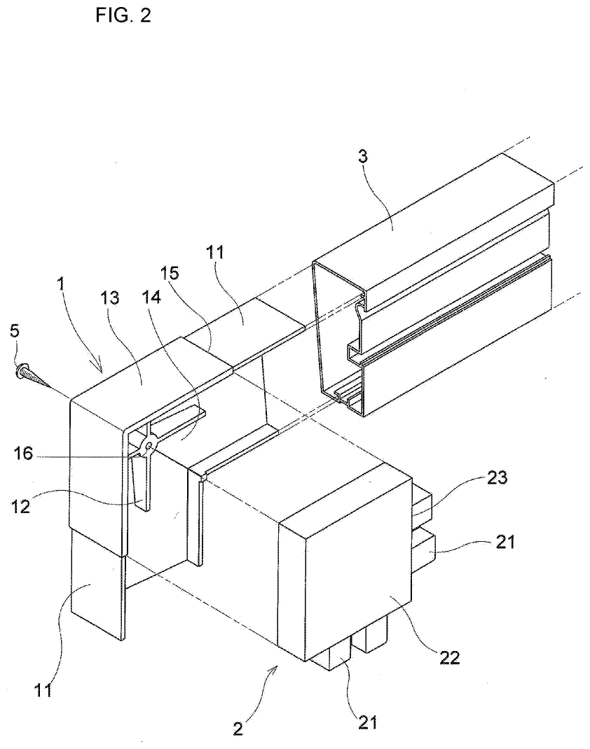

FIG. 2 is an exploded perspective view showing components of a canvas corner fixing device according to the present invention.

According to the present invention, the canvas corner fixing device for an aluminum canvas frame includes canvas frame bodies 3 each made by means of extrusion molding and having a hollow portion 32 formed therein, a corner coupling member 1 having a body 13, a support 12 located at the inside of the body 13, and frame body insertion holes 11 formed on one side in a vertical direction thereof and on one side in a horizontal side thereof, and a fixing member 2 as a square-shaped plate having coupling protrusions 21 protruding from one side in a vertical direction thereof and from one side in a horizontal side thereof.

The canvas frame body 3 as disclosed in Korean Patent Application Laid-open No. 10-2023-0007045 is made by extrusion molding and has the hollow portion 32 formed therein and a fixing groove and a coupling groove formed exposedly on the rear surface thereof so that a plurality of fixing pins 31 are coupled to the canvas frame body 3.

The corner coupling member 1 has a recess 14 formed inside the body 13, the support 12 protruding from the bottom of the recess 14, the frame body insertion holes 11 formed on one side in the vertical direction thereof and on one side in the horizontal side thereof, and stepped projections 15 formed on the boundaries between the frame body insertion holes 11 and the body 13.

The fixing member 2 has a body 22 made of a soft synthetic resin to the form of square, the coupling protrusions 21 protruding from one side in the vertical direction of the body 22 and from one side in the horizontal side thereof, and support projections 23 formed on the boundaries between the coupling protrusions 21 and the body 22.

Under the above-mentioned configuration, if the body 22 of the fixing member 2 comes into close contact with top of the support 12 protruding from the recess 14 of the corer coupling member 1, the coupling protrusions 21 of the fixing member 2 are located inside the frame body insertion holes 11 of the corner coupling member 1, and next, the frame body insertion holes 11 and the coupling protrusions 21 are simultaneously inserted into the hollow portions 32 of the frame bodies 3, thereby completing the assembly of the canvas frame.

When the corner coupling member 1, the fixing member 2, and the frame bodies 3 are coupled to one another, at least three surfaces of each frame body insertion hole 11 come into close contact with the inner surfaces of the hollow portion 32 of the corresponding frame body 3 and are thus coupled to the corresponding frame body 3, and one surface of each coupling protrusion 21 of the fixing member 1 comes into close contact with the support 12 in the recess 14 of the corner coupling member 1, while the other surface thereof is coupled to the inner surface of the frame body 3 coupled thereto.

That is, the frame body insertion holes 11 of the corner coupling member 1 and the coupling protrusions 21 of the fixing member 2 are overlaid on top of each other and inserted into the hollow portions 32 of the frame bodies 3, so that at least three surfaces of each frame body insertion hole 11 come into close contact with the inner surfaces of the hollow portion 32 of the corresponding frame body 3 and are thus coupled to the corresponding frame body 3, and one surface of each coupling protrusion 21 of the fixing member 1 that is inserted into the recess 14 of the corner coupling member 1 in such a way as to be overlaid on the corresponding frame body insertion hole 11 comes into close contact with the hollow portion 32 of the frame body 3, thereby allowing the corner coupling member 1 and the fixing member 2 to be simultaneously coupled to the hollow portions 32 of the frame bodies 3.

According to the present invention, further, when the coupling protrusions 21 of the fixing member 2 are inserted into the recess 14 of the corner coupling member 1 in such a way as to be overlaid on the frame body insertion holes 11, the four surfaces of each coupling protrusion 21 come into close contact with the hollow portion 32 of the corresponding frame body 3, and therefore, it is noted that the support 12 protruding from the recess 14 of the corner coupling member 1 is provided to reduce the material and weight of the corner coupling member 1 or the fixing member 2.

The stepped projections 15, which are formed on the boundaries between the frame body insertion holes 11 and the body 13 of the corner coupling member 1, and the support projections 23, which are formed on the boundaries between the coupling protrusions 21 and the body 22 of the fixing member 2, limit coupled quantities to the frame bodies 3 and allow the body 13 of the corner coupling member 1 and the body 22 of the fixing member 2 to come into close contact with the ends of the frame bodies 3, and the heights of the stepped projections 15 and the support projections 23 are determined to prevent the formation of steps from the coupled boundaries between the corner coupling member 1 and the fixing member 2 coupledly formed along the edges of the frame bodies 3 and the frame bodies 3.

Further, the corner coupling member 1 has a through hole 16 formed on the center of the body 13 in a direction from the outside toward the recess 14 so that the corner coupling member 1 is coupled to the fixing member 2 by means of a fixing screw 5 fastened to the through hole 16.

According to the present invention, furthermore, the corners of the canvas 4, which are not fixed to the frame bodies 3, that is, the canvas 4, which is located at the corners of the canvas frame, is fixed to the fixing member 2 by means of a fixing staple 6.

Explanations of Reference Numerals

| | |
|---|---|
| 1: Corner coupling member | 11: Frame body insertion hole |
| 12: Support | 13: Body |
| 14: Recess | 15: Stepped projection |
| 16: Through hole | 2: Fixing member |
| 21: Coupling protrusion | 22: Body |
| 23: Support projection | 3: Frame body |
| 31: Fixing pin | 32: Hollow portion |
| 4: Canvas | 5: Fixing screw |
| 6: Fixing staple | |

1. A canvas corner fixing device for an aluminum canvas frame, comprising:
canvas frame bodies (3) each made by means of extrusion molding and having a hollow portion (32) formed therein;
a corner coupling member (1) having a body (13), a support (12) located at the inside of the body (13), and frame body insertion holes (11) formed on one side in a vertical direction thereof and on one side in a horizontal side thereof; and
a fixing member (2) as a square-shaped plate having a body (22) and coupling protrusions (21) protruding from one side in a vertical direction thereof and from one side in a horizontal side thereof,
wherein the body (22) of the fixing member (2) is inserted into a recess (14) formed in the body (13) of the corner coupling member (1) in such a way as to come into close contact therewith to allow the coupling protrusions (21) of the fixing member (2) to be located inside the frame body insertion holes (11) and to allow the frame body insertion holes (11) and the coupling protrusions (21) to be simultaneously inserted into the hollow portions (32) of the canvas frame bodies (3), so that the corner coupling member (1), the fixing member (2), and the canvas frame bodies (3) are coupled to one another.

2. The canvas corner fixing device according to claim 1, wherein the support (12) of the corner coupling member (1) is disposed on the bottom of the recess (14).

3. The canvas corner fixing device according to claim 1, wherein the corner coupling member (1) has a through hole (16) formed on the center of the body (13) in a direction from the outside toward the recess (14).
